(19) United States
(12) Patent Application Publication
(10) Pub. No.: US 2016/0192688 A1
(43) Pub. Date: Jul. 7, 2016

(54) Soluble Fiber from Yogurt Whey

(71) Applicant: General Mills, Inc., Minneapolis, MN (US)

(72) Inventors: Tanhia Gonzalez, St. Louis Park, MN (US); Erica Smith, Maple Grove, MN (US)

(73) Assignee: General Mills, Inc., Minneapolis, MN (US)

(21) Appl. No.: 14/911,394

(22) PCT Filed: Aug. 15, 2013
(86) PCT No.: PCT/US13/55142

§ 371 Date: Feb. 10, 2016

(51) Int. Cl. A23C 21/02; A23L 1/29; A23C 9/123

(52) U.S. Cl. CPC A23L 1/308; A23C 21/023; A23V 2002/00

(57) ABSTRACT

A method includes contacting yogurt whey with an enzyme to form a soluble fiber. An oligosaccharide product that includes inactive yogurt cultures is also described.

### BACKGROUND

Separated yogurt production results in about two pounds of whey for every pound of yogurt produced. The whey by-product produced from yogurt is a relatively new by-product resulting from the recent popularity of separated yogurt quite often referred to as “Greek” yogurt. Traditional yogurt production via cup set or stirred-style vat set processes does not produce a yogurt whey by-product stream. Additionally, yogurt whey is unlike whey (i.e., sweet whey) produced from cheese manufacturing. Yogurt whey is more acidic, has less protein, more galactose and a higher mineral content than sweet whey. Currently, yogurt whey is used as an agricultural liquid fertilizer. This liquid yogurt whey, “as is”, does not have suitable characteristics for use in processed foods and animal feed, like other whey by-products.

Soluble fiber includes, for example oligosaccharides. Oligosaccharides are used in many food and feed formulations for their benefits for digestive health and immune enhancing properties. Oligosaccharides such as fructo-oligosaccharides (FOS) and galacto-oligosaccharides (GOS) are prebiotics that are fermented by the probiotic bacteria in the colon into short-chain fatty acids, leading to improved intestinal microflora and other health benefits such as improved mineral absorption. In addition, oligosaccharides act as soluble fibers, delivering flavor enhancement benefits, moisture retention and shelf-life extension properties. Soluble fiber can also be utilized as binding agents for bars, granola, cereal and particulates.

### SUMMARY

The present disclosure relates to the enzyme production of soluble fiber from yogurt whey. In some embodiments galacto-oligosaccharides (GOS) are produced from yogurt whey.

In one illustrative embodiment, a method includes contacting yogurt whey with an enzyme to form a soluble fiber.

In another illustrative embodiment, a soluble fiber composition includes an oligosaccharide and inactive yogurt cultures.

In another illustrative embodiment, a food product includes a soluble fiber and inactive yogurt cultures.

These and various other features and advantages will be apparent from a reading of the following detailed description.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive.

The term “yogurt whey” refers to the acid whey separation byproduct generated from the traditional method of making Greek yogurt. Yogurt whey is a dilute, acidic liquid containing carbohydrates, milk minerals, protein and cultures.

The term “soluble fiber” refers to a water soluble carbohydrate that resists digestion in the small intestine and is fermented in the colon into gases and physiologically active by-products. Soluble fiber can include oligosaccharides. Soluble fiber is a component of dietary fiber. Dietary fiber is defined by CODEX Alimentarius and the methods to measure soluble and total dietary fiber include AOAC Official Method 2011.25 (AACCI 32-50).

As used herein, the terms “oligosaccharide” refers to a compound of three or more monosaccharides and can include polysaccharides.

As used herein, the terms “galacto-oligosaccharide” or “GOS” refer to a compound of three or more monosaccharides, independently selected from the group consisting of glucose and galactose. In one embodiment, GOS may be expressed by a general formula Gal-(Gal)ₙ-Glc (where Gal represents a galactose residue, Glc represents a glucose residue, and n represents an integer between 1 and 10, typically between 1 and 8, and preferably between 2 and 6).

The present disclosure relates to the enzyme production of soluble fiber from yogurt whey. In particular the present disclosure relates to the enzyme production of oligosaccharides such as galacto-oligosaccharides (GOS) from yogurt whey. Yogurt whey has a low protein content and may not need to be purified to remove protein or minerals before the yogurt whey is contacted with the enzyme. The soluble fiber product resulting from the enzyme conversion of yogurt whey can be utilized without filtering out protein or minerals or without other purification techniques like chromatography for example. The oligosaccharide product can be utilized in a variety of food products to provide soluble fiber to the food product. While the present disclosure is not so limited, an appreciation of various aspects of the disclosure will be gained through a discussion of the examples provided below.

Yogurt whey is generated in the food industry as a by-product of the traditional method to make Greek yogurt which involves a whey separation process. The resulting whey is a dilute, high acid liquid containing lactose and milk minerals and is referred to herein as “yogurt whey”. Greek yogurt is produced by the fermentation of milk with yogurt cultures. Three pounds of milk results in one pound of Greek Yogurt and two pounds of yogurt whey. Greek yogurt is separated from yogurt whey and the Greek yogurt is then packaged into containers or further processed. The yogurt whey by-product process stream is often considered a waste product or waste stream.

Yogurt whey that has just been separated from Greek yogurt has a solids content of less than 10% wt or less than 8% wt or about 6% wt. Yogurt whey can have a solids wt % in a range from 3 to 9% wt or from 4 to 8% wt or from 5 to 6% wt.

Yogurt whey that is separated from Greek yogurt includes a relatively large number of yogurt cultures or colony forming units of yogurt cultures. The yogurt cultures used to form Greek yogurt are Lactobacillus delbrueckii subsp. bulgaricus and Streptococcus thermophilus bacteria, among others. In many embodiments, yogurt cultures are present in the yogurt whey. The presence of yogurt cultures can be detected utilizing any known molecular biology technique such as PCR (polymerase chain reaction), for example.

Yogurt whey has a pH that is more acidic than whey produced from cheese (i.e., sweet whey). The pH of yogurt whey can be less than 5.0 or less than 4.8 or 4.5 or less. The pH of yogurt whey can be in a range from 4.0 to 5.0 or from 4.3 to 4.8 or from 4.4 to 4.6. Another way to describe acidity is “titratable acidity” or TA which refers to a total acidity and is expressed as %. Titratable acidity can be determined for yogurt whey by titration with a 0.1 N NaOH solution to a 8.2-8.4 pH using phenolphthalein indicator. Yogurt whey has a TA that is greater than a TA of sweet whey. The TA of yogurt whey is at least about 0.2% or at least 0.3% or at least 0.4%. The TA of yogurt whey can be in a range from 0.2 to 0.5% or from 0.3 to 0.5%.

Yogurt whey has a wt % of protein that is less than whey produced from cheese (i.e., sweet whey). Sweet whey can have about 12% wt protein on a dry basis. Yogurt whey has less than 5% wt or less than 4.5% wt or about 4% wt protein on a dry basis.

Yogurt whey has more calcium than whey produced from cheese (i.e., sweet whey). Yogurt whey has at least two times or at least three times or at least 4 times the amount of calcium as sweet whey. Yogurt whey can have about 100 mg or more calcium per 100 g of yogurt whey. Yogurt whey contains calcium in a range from 100 to 150 mg per 100 g yogurt whey.

Yogurt whey has galactose while sweet whey and other lactose substrates typically do not contain galactose. Yogurt whey can have at least 5% wt galactose or at least 6% wt galactose on a dry basis. Yogurt whey contains an amount of lactose that is similar to sweet whey. Yogurt whey and sweet whey contains about 70% wt lactose on a dry basis or is in a range from 50 to 75% wt lactose on a dry basis.

Soluble fiber can include oligosaccharides such as fructo-oligosaccharides (FOS), galacto-oligosaccharides (GOS), or inulin. These oligosaccharides can be referred to as ‘prebiotics’, which means that they promote beneficial bacteria of the gastrointestinal system and disfavor other bacteria. Soluble fiber is frequently used in functional food products, such as infant formulas and clinical nutrition due to their health promoting effects.

There are several approaches to the production of oligosaccharides or soluble fiber. One approach is based on isolating oligosaccharides from naturally occurring sources. Fructose-oligosaccharide (FOS) and inulin are, for example, found naturally in Jerusalem artichoke, burdock, chicory, leeks, onions and asparagus and may be isolated from these crops. This approach to the production of oligosaccharides is limited by the availability of suitable crops and may be impossible to implement for more complex oligosaccharides.

Another approach is based on enzymatic synthesis in which enzymes catalyze the synthesis of the oligosaccharides. The enzymatic production of fructo-oligosaccharides using enzymes having fructosyltransferase activity has been described using sucrose as substrate for the enzyme. Another example of enzymatic synthesis is a method of producing galacto-oligosaccharides (GOS) of the formula Gal-Gal-Glc using a beta-galactosidase enzyme and lactose (from milk such as sweet whey) as the substrate. This approach has required protein removal (since milk substrates and sweet whey contains at least 10% wt dry basis protein) and chromatographic purification, decolorizing with activated carbon and passing the product through one or more ion-exchange column and is often difficult, complex and expensive to accomplish. In another approach, dry, purified lactose is utilized as the lactose substrate. This process is very costly.

In one illustrative embodiment, a method includes contacting yogurt whey with an enzyme to form a soluble fiber product. In many embodiments the yogurt whey is concentrated to a total solids content in a range from about 40% to about 60% wt before the contacting step. In many embodiments the yogurt whey is pasteurized to kill or inactivate the yogurt cultures or colonies before the contacting step. These processing steps can be performed in any order.

The enzyme can be any enzyme suitable of converting lactose and/or galactose to galacto-oligosaccharide. In many embodiments the enzyme is a beta-galactosidase or beta-glycosidase. Any suitable enzyme or microorganism known in the art, which can convert lactose to a soluble fiber or oligosaccharide, may be employed in the present methods. In some embodiments, the enzyme may be a beta-galactosidase, and the microorganism may be capable of producing beta-galactosidase. In some embodiments, the beta-galactosidase may be obtained from a non-toxigenic, nonpathogenic microorganism. In some embodiments, the enzyme is derived from a host-cell selected from the group consisting of Bifidobacterium, Lactococcus, Lactobacillus, Streptococcus, Leuconostoc, Escherichia, Bacillus, Streptomyces, Saccharomyces, Kluyveromyces, Candida, Torula, Torulopsis and Aspergillus. In some embodiments, the beta-galactosidase is derived from Cryptococcus laurentii, Aspergillus oryzae, Aspergillus nigar; Bacillus circulans, Bacillus subtilis, Bacillus licheniformis, Lactobacillus bulgaricus, Streptococcus thermophilus, Bullera singularis, Bifidobacterium breve, Bifidobacterium longum, Bifidobacterium infantis, Bifidobacterium bifidum, Lactococcus lactis, Candida pseudotropicalis, or Kluyveromyces lactis.

The lactose conversion rate can be from about 50% to about 92% depending on the enzyme and conversion process conditions. The conversion pH can range from 4.5 to 7.0. The pH of yogurt whey is in a range from 4.5 to 5.5, thus the pH may not need to be adjusted when the conversion pH is in that range. If the conversion pH is greater than this range, the pH of the yogurt whey or concentrated yogurt whey can be adjusted utilizing a basic material such as a hydroxide such as alkali metal hydroxides or alkali earth metal hydroxides. Alkali metal hydroxides include sodium and potassium hydroxide. Alkali earth metal hydroxides include calcium and magnesium hydroxide. In some embodiments the basic material is a carbonate such as sodium bicarbonate.

The soluble fiber product composition has less than 5% wt protein on a dry basis. This is because the yogurt whey has less than 5% wt protein on a dry basis. The soluble fiber product can be concentrated to any suitable total solids content. In many preferred embodiments, the soluble fiber product composition has a total solids content of at least about 70% wt and a total soluble fiber of at least about 65% wt with at least 3 degrees of polymerization (DP). In some preferred embodiments, the soluble fiber product composition has a total solids content of at least about 95% wt and a total soluble fiber of at least about 90% wt with at least 3 degrees of polymerization (DP).

Thus the soluble fiber product composition that is converted from yogurt whey can be a useful source of soluble fiber that can be incorporated into food products as either a liquid concentrate or dried powder ingredient. The soluble fiber product composition described herein does not need to be purified like conventional soluble fiber product. The soluble fiber product composition described herein has a low protein content since the yogurt whey has a low protein content. Thus, protein separation processes are not needed in the process described herein.

In many embodiments the soluble fiber product is incorporated into a food product as a liquid concentrate or syrup. In some embodiments the soluble fiber product composition is dried utilizing any useful drying method and then incorporated into a food product. In some of these embodiments the soluble fiber product can be dried with a spray dryer, drum dryer, an oven dryer, a freeze dryer, or any other known drying equipment or process.

In some embodiments the resulting soluble fiber liquid or powder concentrate product described herein can replace FOS in food products. The soluble fiber can be combined to form any number of food products such as: cereal, baked goods, snack bars, sauces, and fruit snacks for example.

Thus, embodiments of SOLUBLE FIBER FROM YOGURT WHEY are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method comprising:
contacting yogurt whey with an enzyme to form a soluble fiber.

2. The method according to claim 1, further comprising pasteurizing the yogurt whey and the yogurt whey comprises yogurt cultures.

3. The method according to claim 1, wherein the yogurt whey has less than 5% wt protein on a dry basis.

4. The method according to claim 1, wherein the yogurt whey comprises galactose.

5. The method according to claim 4, wherein the yogurt whey comprises at least about 5% wt galactose on a dry basis.

6. The method according to claim 1, further comprising concentrating the yogurt whey to a total solids content in a range from about 40% to about 60% wt before the contacting step.

7. The method according to claim 1, wherein the enzyme comprises beta-galactosidases or beta-glycosidases.

8. The method according to claim 1, further comprising incorporating the soluble fiber into a food product.

9. The method according to claim 1, wherein the soluble fiber comprises galacto-oligosaccharide.

10. A soluble fiber composition comprising:
an oligosaccharide; and
inactive yogurt cultures.

11. The soluble fiber composition according to claim 10, further comprising less than 5% wt protein on a dry basis.

12. The soluble fiber composition according to claim 10, comprising a total solids content of at least about 70% wt and a total soluble fiber of at least about 65% wt with at least 3 degrees of polymerization (DP).

13. The soluble fiber composition according to claim 10, comprising a total solids content of at least about 95% wt and a total soluble fiber of at least about 90% wt with at least 3 degrees of polymerization (DP).

14. The soluble fiber composition according to claim 10, wherein the soluble fiber oligosaccharide comprises galacto-oligosaccharide.

15. A food product comprising the soluble fiber composition of claim 10.

16. A food product according to claim 15, wherein the oligosaccharide comprises galacto-oligosaccharide.
